(19) United States
(12) Patent Application Publication
(10) Pub. No.: US 2024/0095537 A1
(43) Pub. Date: Mar. 21, 2024

(54) UNKNOWN-CLASS (OUT-OF-DISTRIBUTION) DATA DETECTION IN MACHINE LEARNING MODELS

(71) Applicant: University of Central Florida Research Foundation, Inc., Orlando, FL (US)

(72) Inventors: Umar Khalid, Orlando, FL (US); Nazanin Rahnavard, Orlando, FL (US); Alireza Zaeemzadeh, Orlando, FL (US)

(21) Appl. No.: 18/456,258

(22) Filed: Aug. 25, 2023

Related U.S. Application Data
(60) Provisional application No. 63/400,970, filed on Aug. 25, 2022.

(51) Int. Cl. G06N 3/0895

(52) U.S. Cl. CPC G06N 3/0895

(57) ABSTRACT

Described, herein, relates to a system of and method for digitally monitoring a large-scale dataset on a computing device and automatically detecting, in real-time, unknown class data in order to aid a machine learning model. Once machine learning models are deployed in the real-world applications, the models tend to encounter unknown-class (i.e., out-of-distribution) (hereinafter “OOD”) data during inference. Detecting out-of-distribution data is a crucial task in safety-critical applications to ensure safe deployment of deep learning models. It is desired that the machine learning model should only be confident about the type of data that has already seen in-distribution (hereinafter “ID”) class data which reinforces the driving principle of the OOD detection. The system and method may rely on contrastive feature learning of the largescale datasets, where the embeddings lie on a compact low-dimensional space. Additionally self-supervised fine-tuning may then be performed by mapping an ID class feature into uni-dimensional sub-space.

### CROSS-REFERENCE TO RELATED APPLICATIONS

This nonprovisional application claims the benefit of U.S. Provisional Application No. 63/400,970 entitled “UNKNOWN-CLASS (OUT-OF-DISTRIBUTION) DATA DETECTION IN MACHINE LEARNING MODELS” filed Aug. 25, 2022 by the same inventors, all of which is incorporated herein by reference, in its entirety, for all purposes.

### BACKGROUND OF THE INVENTION

### 1. Field of the Invention

This invention relates, generally, to data classification. More specifically, it relates to a system of and method for digitally monitoring a large-scale dataset, in real-time, on a computing device and automatically detecting, in real-time, unknown class data in order to aid a machine learning model.

### 2. Brief Description of the Prior Art

Machine learning models are generally exposed to unknown-class (i.e., out-of-distribution) (hereinafter “OOD”) data which they have not experienced during standard training. Detecting such OOD samples is of paramount importance in safety-critical applications such as healthcare and autonomous driving. As such, currently known techniques have started to address the issue of OOD detection. Accordingly, generative models and auto-encoders have been proposed to tackle OOD detection, however, they require OOD samples for hyper-parameter tuning. Furthermore, recent advances in OOD detection have enabled the use of membership probabilities, and/or feature embeddings to calculate an uncertainty score. However, the currently known techniques using this technology must rely on either reconstruction or generation, which degrades the OOD detection on large-scale datasets or video classification scenarios.

Accordingly, what is needed is an efficient, easy-to-use method for automatically detecting OOD data for large-scale datasets. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to method of detecting an unknown class data set within a largescale dataset. In an embodiment, the method may comprise the following steps: (a) loading, into a memory of a computing device, a predetermined largescale dataset, such that the largescale dataset may comprise a plurality of in-distribution (hereinafter “ID”) class data; (b) pre-training, via at least one processor of the computing device, the predetermined largescale dataset, such that the plurality of ID class data may be augmented with the adversarial perturbations; (c) calculating, via the at least one processor of the computing device, at least one singular vector for the plurality of augmented ID class data, establishing at least one ID class associated with the plurality of augmented ID class data; (d) comparing, via the at least one processor of the computing device, a largescale dataset comprising a plurality of out-of-distribution (hereinafter “OOD”) class data with the at least one singular vector r; and (e) automatically displaying, an uncertainty score of the largescale dataset on a display device associated with the computing device by: (i) based on a determination that the at least one datapoint of the plurality of OOD class data matches the at least one singular vector, labeling and/or recording, in real-time, the at least one datapoint into the at least one ID class; and (ii) based on a determination that the at least one datapoint of the plurality of OOD class data does not match the at least one singular vector, labeling and/or recording, in real-time, the at least one datapoint into the at least one new OOD category.

In some embodiments, the step of calculating the at least one singular vector may further comprise, determining the at least one singular vector comprising the majority of augmented ID class data. In these other embodiments, the plurality of augmented ID class data may be inputted into a singular value decomposition algorithm.

In addition, in some embodiments, when comparing the largescale dataset comprising the plurality of OOD class data with the at least one singular vector, the at least one singular vector may be the at least one singular vector comprising the majority of augmented ID class data. In this manner, the step of comparing the largescale dataset comprising the plurality of OOD class data with the at least one singular vector may further comprise, measuring the angular similarity between the plurality of OOD class data with the at least one singular vector.

In some embodiments, the largescale dataset may be compared to the at least one singular vector using cosine similarity. As such, the method may further comprise the step of, fine-tuning, via the at least one processor of the computing device, the at least one singular vector using cross-entropy loss. In these other embodiments, the at least one singular vector may be orthogonal to at least one alternative singular vector. In this manner, in some embodiments, the step of fine-tuning the at least one singular vector may also comprise, scaling, via the at least one processor of the computing device, the at least one singular vector with at least one sharpening function, increasing a confidence in the at least one singular vector.

Moreover, another aspect of the present disclosure pertains to a dataset monitoring optimization system. In an embodiment, the dataset monitoring optimization system may comprise the following: (a) a computing device having at least one processor; and (b) a non-transitory computer-readable medium having stored thereon computing device-executable instructions that, when executed by the at least one processor, cause the computing device to perform operations comprising: (i) loading, into a memory of a computing device, a predetermined largescale dataset, such that the largescale dataset may comprise a plurality of in-distribution (hereinafter “ID”) class data; (ii) pre-training, via at least one processor of the computing device, the predetermined largescale dataset, such that the plurality of ID class data may be augmented with the adversarial perturbations; (iii) calculating, via the at least one processor of the computing device, at least one singular vector for the plurality of augmented ID class data, establishing at least one ID class associated with the plurality of augmented ID class data; (iv) comparing, via the at least one processor of the computing device, a largescale dataset comprising a plurality of out-of-distribution (hereinafter “OOD”) class data with the at least one singular vector; and (v) automatically displaying, an uncertainty score of the largescale dataset on a display device associated with the computing device by: (A) based on a determination that the at least one datapoint of the plurality of OOD class data matches the at least one singular vector, labeling and/or recording, in real-time, the at least one datapoint into the at least one ID class; and (B) based on a determination that the at least one datapoint of the plurality of OOD class data does not match the at least one singular vector, labeling and/or recording, in real-time, the at least one datapoint into the at least one new OOD category.

In some embodiments, the operation of calculating the at least one singular vector may further comprise, determining the at least one singular vector comprising the majority of augmented ID class data. In these other embodiments, the plurality of augmented ID class data may be inputted into a singular value decomposition algorithm.

In addition, in some embodiments, when comparing the largescale dataset comprising the plurality of OOD class data with the at least one singular vector, the at least one singular vector may be the at least one singular vector comprising the majority of augmented ID class data. In this manner, the operation of comparing the largescale dataset comprising the plurality of OOD class data with the at least one singular vector may further comprise, measuring the angular similarity between the plurality of OOD class data with the at least one singular vector.

In some embodiments, the largescale dataset may be compared to the at least one singular vector using cosine similarity. As such, the method may further comprise the operation of, fine-tuning, via the at least one processor of the computing device, the at least one singular vector using cross-entropy loss. In these other embodiments, the at least one singular vector may be orthogonal to at least one alternative singular vector. In this manner, in some embodiments, the operation of fine-tuning the at least one singular vector may also comprise, scaling, via the at least one processor of the computing device, the at least one singular vector with at least one sharpening function, increasing a confidence in the at least one singular vector

Furthermore, an additional aspect of the present disclosure pertains to a method of detecting an unknown class data set within a largescale dataset. In an embodiment, the method may comprise the following steps: (a) calculating, via the at least one processor of the computing device, at least one singular vector for a plurality of in-distribution (hereinafter “ID”) class data of a predetermined largescale dataset, establishing at least one ID class associated with the plurality of ID class data; (b) comparing, via the at least one processor of the computing device, a largescale dataset comprising a plurality of out-of-distribution (hereinafter “OOD”) class data with the at least one singular vector; and (c) automatically displaying, an uncertainty score of the largescale dataset on a display device associated with the computing device by: (i) based on a determination that the at least one datapoint of the plurality of OOD class data matches the at least one singular vector, labeling and/or recording, in real-time, the at least one datapoint into the at least one ID class; and (ii) based on a determination that the at least one datapoint of the plurality of OOD class data does not match the at least one singular vector, labeling, and/or recording, in real-time, the at least one datapoint into the at least one new OOD category.

In some embodiments, the method may further comprise the step of, pre-training, via at least one processor of the computing device, the predetermined largescale dataset, wherein the plurality of ID class data is augmented with the adversarial perturbations.

In some embodiments, the present disclosure may be configured to leverage a pre-trained model with self-supervised contrastive learning. As such, the system may be configured to yield a better model for unidimensional feature learning in the latent space, such that a self-supervised adversarial contrastive learning may be performed. Additionally, in these other embodiments, the system may comprise an encoder which may be configured to be fine-tuned by freezing at least one Weight (W) of a penultimate layer.

In this manner, in some embodiments a column of W may be initialized to be orthonormal. As such, the orthogonality constraint may be configured to ensure a unidimensional mapping of at least one class feature where features belonging to at least one class may be forced to be orthogonal to the features of the other ID class. Moreover, in these other embodiments, by employing at least one singular value decomposition (SVD), the system may be configured to calculate at least one singular vector of each class using its features.

Furthermore, in some embodiments, only one singular vector which dominates the entire feature mapping of its class may be saved within the system for an OOD detection test. In this manner, after learning the one-dimensional mapping of the ID classes, at least one representative singular vector may be calculated for each class which is then used for the OOD detection test. Furthermore, in these other embodiments, the final step within the sequence may comprise OOD detection.

In addition, in some embodiments, the OOD detection may be performed during deployment, where an uncertainty score may be estimated using a cosine similarity between the feature vector (Ft) representing the test sample t and first singular vector of each ID class. In some embodiments, BN may represent a Batch Normalization, a common regularization technique in deep learning, L may represent a number of classes, and δ^{th} may represent a threshold for the uncertainty score

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a process flow diagram depicting a method of automatically detecting unknown-class data via a machine learning model of a computing device, according to an embodiment of the present disclosure.

FIG. 2A is an exemplary configuration of a contrastive pre-training stage for detecting a sequence of OOD within a OOD dataset, such that adversarial contrastive learning is performed, according to an embodiment of the present disclosure. In FIG. 2A, BN represents a Batch Normalization, L is a number of classes, and 3 th is a threshold for an uncertainty score

FIG. 2B is an exemplary configuration of a fine-tuning stage for detecting a sequence of OOD within a OOD dataset, such that an encoder is fine-tuned by freezing a Weight of a penultimate layer, according to an embodiment of the present disclosure. In FIG. 2B, BN represents a Batch Normalization, L is a number of classes, and 3 th is a threshold for an uncertainty score.

FIG. 2C is an exemplary configuration of a singular value decomposition (hereinafter “SVD”) stage for detecting a sequence of OOD within a OOD dataset, such that a first singular vector of each class using its features is calculated, according to an embodiment of the present disclosure. In FIG. 2C, BN represents a Batch Normalization, L is a number of classes, and δ^{th} is a threshold for an uncertainty score.

FIG. 2D is an exemplary configuration of a OOD detection stage, such that an uncertainty score is estimated using cosine similarity between a feature vector (Fₜ) representing the OOD dataset t and first singular vector of each ID class, according to an embodiment of the present disclosure. In FIG. 2D, BN represents a Batch Normalization, L is a number of classes, and δ^{th} is a threshold for an uncertainty score

FIG. 3 is an exemplary configuration of an orthogonality check of an OOD dataset, according to an embodiment of the present disclosure.

FIG. 4A is a data plot of features extracted from a conventional deep learning model with a severity level 1 for a t-SNE representation of features extracted by introducing Gaussian noise an OOD dataset, according to an embodiment of the present disclosure, For FIG. 4A, 10,000 samples from a TINc test set and a LSUNc test set were used, in addition to 1,000 samples of each class from an ID CIFAR-10 test set, to generate 2D t-SNE plot.

FIG. 4B is a data plot of features extracted using Robust OOD detection (hereinafter “ROOD”) with a corruption severity level 1 for a t-SNE representation of features extracted by introducing Gaussian noise an OOD dataset, according to an embodiment of the present disclosure. For FIG. 4B, 10,000 samples from a TINc test set and a LSUNc test set were used, in addition to 1,000 samples of each class from an ID CIFAR-10 test set, to generate 2D t-SNE plot.

FIG. 4C is a data plot of features extracted using ROOD with a corruption severity level 5 for a t-SNE representation of features extracted by introducing Gaussian noise an OOD dataset, according to an embodiment of the present disclosure. For FIG. 4C, 10,000 samples from a TINc test set and a LSUNc test set were used, in addition to 1,000 samples of each class from an ID CIFAR-10 test set, to generate 2D t-SNE plot.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention. Elements/components shown in diagrams are illustrative of exemplary embodiments of the disclosure and are meant to avoid obscuring the disclosure. Any headings, used herein, are for organizational purposes only and shall not be used to limit the scope of the description or the claims. Furthermore, the use of certain terms in various places in the specification, described herein, are for illustration and should not be construed as limiting.

### Definitions

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wireline, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++, Python, Swift, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “Application Programming Interface” (hereinafter “API”) refers to any programming or software intermediary that allows an application to communicate with a third-party application. For ease of reference, the exemplary embodiment, described herein, refers to a programming which communicates with hotel, airfare, golf, spa, and rental car applications, but this description should not be interpreted as exclusionary of other types of third-party applications.

As used herein, the term “computing device” refers to any functional electrical component known in the art which can perform substantial computations, including numerous arithmetic operations and/or logic operations without human intervention. Non-limiting examples of the computing device may include a laptop, a mobile device, a computer, and/or a tablet. For ease of reference, the exemplary embodiment described herein refers to a mobile device and/or a computer, but this description should not be interpreted as exclusionary of other functional electrical components.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” as used herein refer to being within an acceptable error range for the particular value as determined by one of ordinary skill in the art, which will depend in part on how the value is measured or determined, i.e., the limitations of the measurement system, i.e., the degree of precision required for a particular purpose, such real-time pricing of an activity and/or hotel. As used herein, “about,” “approximately,” or “roughly” refer to within +15% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Robust OOD Detection System

The present disclosure pertains to a system and method of digitally monitoring a largescale dataset and/or automatically detecting, in real-time, unknown class (hereinafter “OOD”) data to aid machine learning. Furthermore, the largescale dataset of the machine learning module may be immediately broken down between at least one in-distribution (hereinafter “ID”) class data and/or OOD data, such that the OOD data of the largescale dataset is detected and/or categorized, and/or the machine learning module's may be notified of the unidentified class. As such, similar structured unknown classes may be further detected and/or categorized by the system. The system and method will be described in greater detail in the sections herein below.

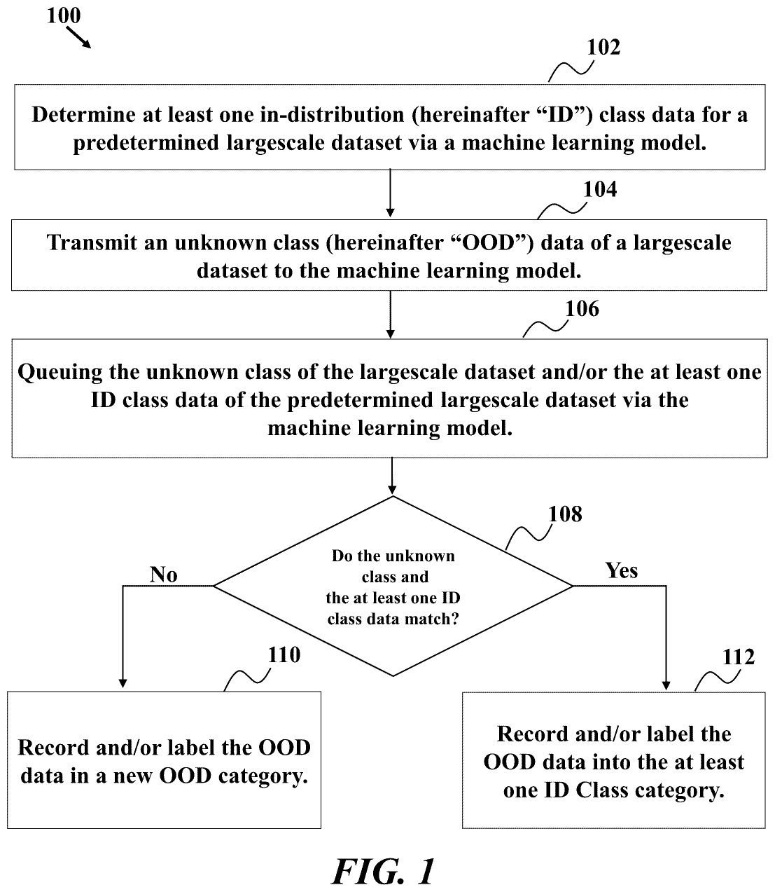

FIG. 1 depicts a process flow diagram depicting a method 100 of automatically detecting unknown-class data via a machine learning model of a computing device, according to an embodiment of the present disclosure. The steps delineated in FIG. 1 are merely exemplary of an order of modifying notifications of an application. The steps may be carried out in another order, with or without additional steps included therein.

As shown in FIG. 1, method 100 begins at step 102, in which at least one ID Class data is determined for a machine learning model, via a computing device. In an embodiment, this step includes at least one processor of the computing device receiving a selection of at least one ID class data, such as from a user, via at least one user interface, and/or the computing device. In this embodiment, the at least one ID class data may then be stored within the memory of the machine learning model, such that the machine learning model may access the memory prior to detecting the at least one ID class with a largescale dataset on the computing device.

Next, at step 104, the processor of the computing device may be configured to transmit an unknown class (hereinafter “OOD”) data of the largescale dataset via the supervised finetuned machine learning model to a memory of the computing device. For example, in some embodiments, if the largescale dataset is an autonomous driving input data that is executable and launched on the computing device, the processor may transmit the standardized notification to the machine learning model. Further, in an embodiment, at step 106, the machine learning model may be configured to queue the OOD data of the largescale dataset, such as the at least one ID class data for the largescale dataset. Following the machine learning model queuing the notification of the application, at step 108, the machine learning model may then compare the received OOD data of the largescale dataset from the at least one ID class data for that specific largescale dataset. Finally, the method may then proceed to either step 110 or step 112 depending on whether a substantial match exists between the OOD data of the largescale dataset and the at least one ID class data of the largescale dataset.

During step 110, in an embodiment, the machine learning model of the system may determine that a substantial match does not exist between the OOD data of the largescale dataset and the at least one ID class data of the largescale dataset. As such, during step 110, the machine learning model may execute and/or transmit at least one instruction to document and/or label the OOD data for the largescale dataset. Therefore, in this embodiment, the machine learning model of the robust OOD detection system communicatively coupled with the computing device may generate at least one new OOD data category for the largescale dataset.

During step 112, in an embodiment, the machine learning model of the robust OOD detection system may determine that a substantial match does exist between the OOD data of the largescale dataset and the at least one ID class data of the largescale dataset. Accordingly, during step 112, the machine learning model may execute and/or transmit at least one instruction to document the OOD data as at least one ID class data of the largescale dataset. Furthermore, the machine learning model of the robust OOD detection system may then categorize the OOD data into the at least one ID class data of the largescale dataset, such that the machine learning model may incorporate the OOD data within the memory of the computing device, optimizing the ability to monitor and/or detect the OOD data of the largescale dataset without suffering from detractions, such as requiring hyper-parameter tuning and/or relying on reconstruction and/or generation.

In an embodiment, OOD data detection of the robust OOD detection system may build upon employing at least one training block configured to extract at least one feature from the ID dataset. As such, the at least one training block may be self-supervised. As such, in this embodiment, the at least one processor may be configured to receive the at least one training block from the memory of the computing device and/or receive at least one signal from at least one third-party dataset comprising the at least one training block, via the at least one processor being communicatively coupled to at least one Application Program Interface (hereinafter “API”). In this embodiment, the at least one feature may comprise robust features from the ID dataset.

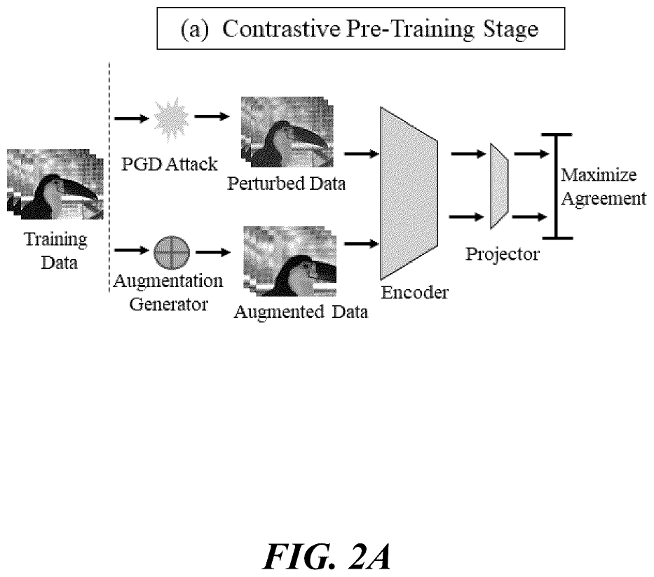

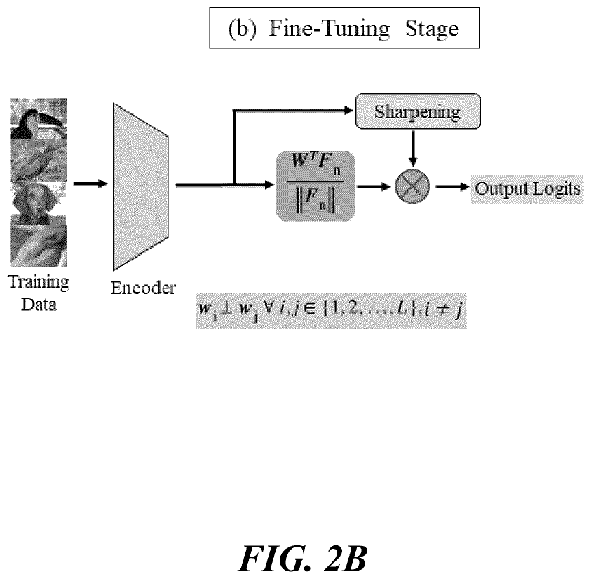

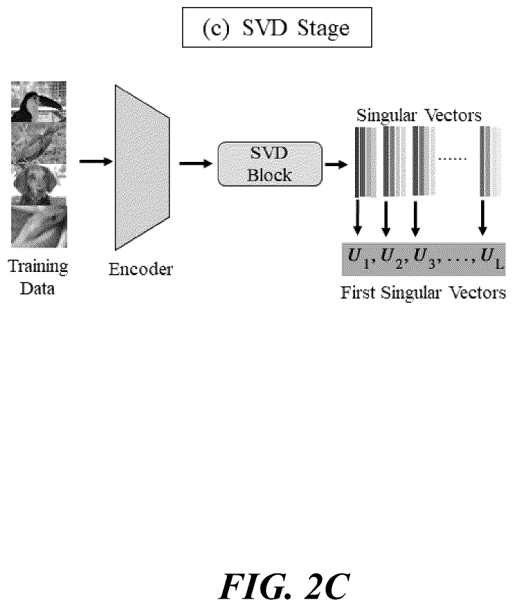

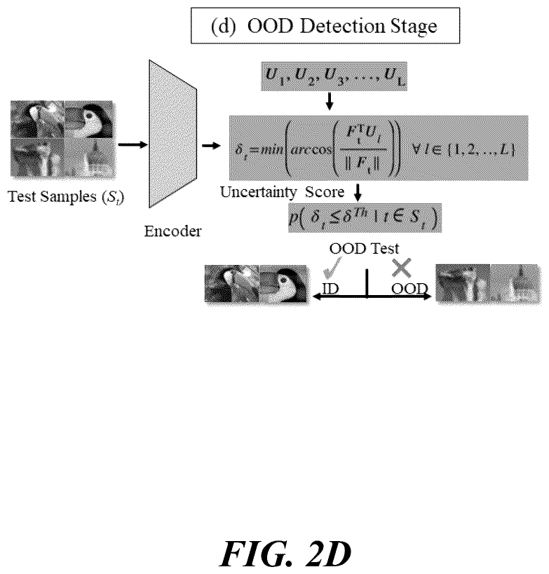

As shown in FIG. 2A, in an embodiment, the at least one processor of the robust OOD detection system may be configured to carry out OOD data detection by pre-training a contrastive loss on ID data. In this embodiment, at least one union of one-dimensional embeddings may be utilized, via the at least one processor of the robust OOD detection system, to project at least one deep feature of different classes onto at least one-dimensional predefined vector and/or at least one mutually orthogonal predefined vector representing at least one class to obtain at least one logit.

Moreover, as shown in FIG. 2B, in this embodiment, the robust OOD detection system may be configured to fine-tune and/or sharpen the at least one logit. As such, at the final layer's output, a cross-entropy between the logit probability output and the labels to form the supervised loss may then be evaluated by the robust OOD detection system. In this manner, during the evaluation, the at least one processor may be configured to carry out the uni-dimensional mapping, such that at least one intra-class distribution may be guaranteed to consist of at least one sample aligning the most with the at least one uni-dimensional vector characterizing the at least one sample. In addition, the robust OOD detection system may be configured to transmit the uni-dimensional mapping to the memory of the computing device. In addition, the robust OOD detection system may be configured to transmit the uni-dimensional mapping to a display device communicatively coupled to the computing device associated with the robust OOD detection system.

Furthermore, as shown in FIG. 2B, in this manner, the penultimate layer of the model may be modified, via the at least one processor, by using a cosine similarity and/or introducing at least one sharpening layer, where output logits may be calculated as,

$$P ( {F}_{n} ) = \frac{Z ( {F}_{n} )}{G ( {F}_{n} )} .$$

The equation showing how the penultimate layer of the model may be modified is provided below, as follows:

$$Z ( {F}_{n} ) = \frac{{W}^{T} {F}_{n}}{‖ {F}_{n} ‖} , G ( {F}_{n} ) = σ ( B N ( {W}_{g}^{T} {F}_{n} ) ) \qquad ( 1 )$$

The equation, as seen above, has an “Fₙ” variable which represents an encoder output for the training sample n, a “a” variable which represents the sigmoid function, and a “W_{g}” variable which represents the weight matrix for the sharpening layer, represented by G(Fₙ), which essentially maps Fₙ to a scalar value. In an embodiment, in the at least one sharpening layer, the batch normalization (BN) may be used for faster convergence. Additionally, in some embodiments, at least one bias vector may be calculated for at least one of the penultimate layer and/or at least one sharpening layer.

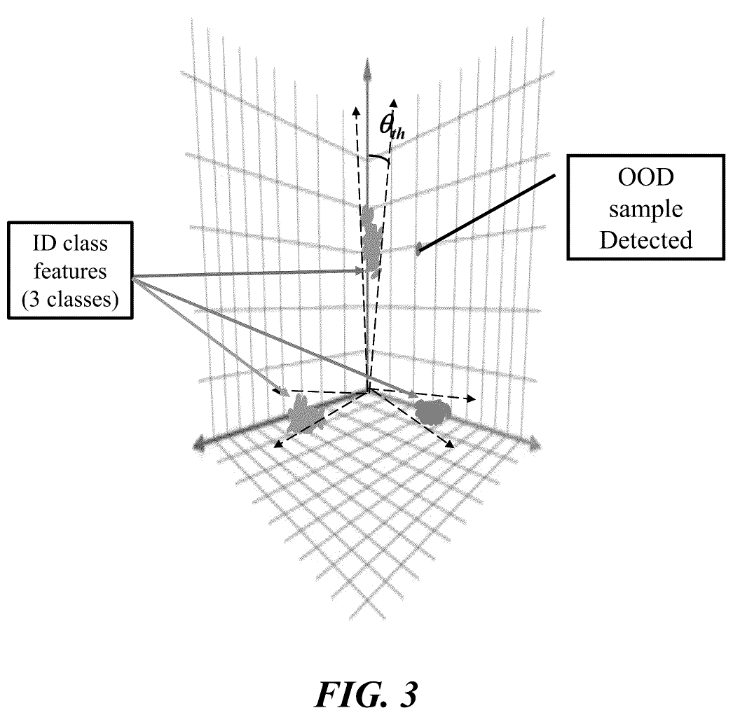

FIG. 3 depicts an exemplary configuration of an orthogonality check of the at least one OOD dataset by the robust OOD detection system, according to an embodiment of the present disclosure. Accordingly, in an embodiment, the orthogonality may come with at least one wide angle between the at least one uni-dimensional embedding of the at least one separate class, such that a large and expanded rejection region may be created for the at least one OOD sample, if the at least one OOD sample lie in a vast inter-class space. In this embodiment, in order to achieve the orthogonality, the weight matrix W=[w₁, w₂ . . . wₗ] of the penultimate layer with orthonormal vectors may be initialized and/or then may be frozen during the fine-tuning stage, via the at least one processor, as shown in FIG. 2B. In this manner, the weight matrix comprises a “wₗ” variable which represents the weights of the last fully connected layer corresponding to class l. As shown in FIG. 3, the at least one feature may be projected onto a predefined set of orthogonal vectors wₗ for 1=1, 2, . . . , L, where a “L” variable represents the number of ID classes.

Additionally, as shown in FIG. 2C and FIG. 2D, in an embodiment, after training, the robust OOD detection system may be configured to conduct OOD by evaluating at least one inner product between the calculated first singular vectors (U₁,U₂ . . . , UL), via SVD, which represent a corresponding class, and/or an at least one extracted feature for a sample of interest. In this embodiment, as shown in FIG. 2D, in order to perform an OOD inspection on the test sample t ∈Sₜ, where a “Sₜ” variable represents the test set, an uncertainty score may be generated by the at least one processor of the robust OOD detection system. The equation showing how the uncertainty score may be determined is provided below:

$${δ}_{t} = min ( arccos ( \frac{{F}_{t}^{T} {U}_{t}}{‖ {F}_{t} ‖} ) ) , ∀ 1 ∈ \{ 1 , 2 , … , L \} \qquad ( 2 )$$

In the equation, as shown above, “Fₜ” variable represents the output of the encoder for the test sample t. In an embodiment, the robust OOD detection system, via the at least one processor, may then use the measured uncertainty to calculate a probability that t belongs to ID and/or OOD using a probability function, p(δₜ≤δ^{th}|t ∈Sₜ). In this embodiment, the at least one feature of ID class l may be aligned with the corresponding wₗ, where wₗ may represent the “lth” column of matrix W. As such, δ^{th} may equal 0. However, in some embodiments, all class features may not be exactly aligned with each respective column in W, such that the robust OOD detection system may be configured to use the first singular vector of each class feature matrix separately.

Furthermore, as shown in FIG. 2B, another feature of the present disclosure is that the robust OOD detection system may comprise a contrastive learning pretraining and/or sharpening module, such that OOD detection, G(Fₙ), may be optimized. As such, in this embodiment, at least one weight of an encoder of the robust OOD detection system may not be frozen after the contrastive learning. Accordingly, the robust OOD detection system may be configured to finetune the weights along the training procedure, via a cross entropy loss. Moreover, the features may be warm-started with at least one initialized value, which may be derived from the contrastive loss pretraining, such that the final objective function may be composed of two terms [symbol] _{CL}+μ [symbol] _{LL}, where a “ [symbol] _{CL}” variable and a “ [symbol] _{LL}” variable represent the contrastive and cross-entropy losses, respectively. In addition, the cross-entropy loss may impose the orthogonality assumption infused by the choice of orthogonal matrix, as shown in FIG. 3, containing union of wₗ∀1 ∈{1, 2, . . . , L}, each of which represent at least one class. By feeding the inner products of features with W into [symbol] _{LL}, the at least one feature may be endorsed to get reshaped to satisfy orthogonality and rotate to align wₗ.

Furthermore, as shown in FIG. 3, in conjunction with FIG. 2A, in an embodiment, by augmenting the data of each class with at least one adversarial perturbation, via the at least one processor of the robust OOD detection system, a classification performance on ID perturbed data may be optimized, while OOD data may still be detected. As such, in this embodiment, the perturbed data and/or the augmented data may be encoded and/or projected into the largescale dataset, via the at least one processor, such that the robust OOD detection system may be configured to generate a maximize agreement (e.g., an acceptance range) for each uni-dimensional mapping. In this manner, prior to implementing at least one inner product for supervised training, the uni-dimensional mappings may be modified, via the at least one processor, using G(Fₙ) to optimally benefit from the learned features. As such, as shown in FIG. 2B, in this embodiment, in order to compensate for the uni-dimensional confinement, the sharpening concept may be implemented, such that the confidence of the obtained logit vector may be enhanced by scaling the inner products with a factor denoted with the sharpening function G(Fₙ).

In an embodiment, the objective function may also be composed of a contrastive loss and/or a SoftMax cross entropy. Accordingly, in this embodiment, a least squared loss measuring the distance between linear prediction on a sample's extracted feature to its label vector ∥W^{T}Fₙ−yₙ∥₂² as a surrogate for the softmax cross entropy ( [symbol] _{LL}) may be used. In this manner, the east squared loss ( [symbol] _{LL}) may measure the distance of the final layer predictions, assuming linear predictor in the deep feature space, from the one-hot encoded vector. In some embodiments, the east squared loss may measure the distance of the final layer predictions from at least one logit, if available.

Additionally, in an embodiment, A=[αᵢⱼ] represents the adjacency matrix for the augmentation graph of training data formally defined. In general, the robust OOD detection system may connect, via the at least one processor, at least two samples through an edge on a graph if it is assumed that the at least two samples are generated from the same class distribution. Without loss of generality, the adjacency matrix may be block-diagonal (e.g., the different classes are well-distinguished). Therefore, the robust OOD detection system may be configured to partition the problem into data specific to each class. For example, F and Y may represent the matrix of all features and label vectors, (e.g., Fₙ and yₙ), such that the “n” variable may represent the “nth” sample, respectively. As such, the training loss may include one term for contrastive learning loss and/or one for the supervised uni-dimensional embedding matching. The equation showing how the training loss comprising one term for contrastive learning loss and/or one for the supervised uni-dimensional embedding matching may be calculated is provided below, as follows:

$$ℒ ( F ) = \begin{matrix}\underbrace{{‖ A - F {F}^{T} ‖}_{F}^{2}} \\ {ℒ}_{C L} ( F )\end{matrix} + μ \begin{matrix}\underbrace{{‖ {W}^{T} F - Y ‖}_{F}^{2}} \\ {ℒ}_{L L} ( F )\end{matrix} \qquad ( 3 )$$

In the above equation, “Y” and “A” represent given matrices, and “W” represents being fixed to some orthonormal predefined matrix. The optimization variable may therefore be the matrix F. The equation showing show the optimization problem may be calculated is provided below, as follows:

$$\begin{matrix}min \\ F\end{matrix} {‖ A - F {F}^{T} ‖}_{F}^{2} + μ {‖ {W}^{T} F - Y ‖}_{F}^{2} \qquad ( 4 )$$

Furthermore, in an embodiment, two assumptions associated with the optimization problem may be included, via the at least one processor, on the structure of the adjacency matrix arising from its properties: (a) for a triple of images xᵢ, xⱼ,

$${x}_{s} , \frac{{a}_{i , j}}{{a}_{j , s}} ∈ [ \frac{1}{1 + δ} , 1 + δ ]$$

for small δ, (e.g., samples of the same class are similar); and (b) for a quadruple of images xᵢ, xⱼ, xₛ, xₜ, where xᵢxⱼ are from different classes and xₛ, xₜ are from the same classes

$$\frac{{a}_{i , j}}{{a}_{s , t}} \leq η$$

for small η.

Lemma 1. Let F* denote the solution to minF [symbol] _{CL} (first loss term in equation (4)). In this embodiment, F* may be assumed be decomposed as F*=ΣV^{T}. Under Assumptions (a) and (b), as shown above, for F* with singular values σᵢ, the associated equation may comprise

$${\sum }_{i = 2}^{{N}_{l}} {σ}_{i}^{2} \leq \sqrt{6 ( {( 1 + δ )}^{\frac{3}{2}} - 1 )}$$

for some small δ, where σᵢ=Σᵢᵢ, and Nₗ is the number training samples of class l.

Proof 1. Additionally, it may be shown that

$${\sum }_{i = 2}^{{N}_{l}} {σ}_{i}^{4} \leq 2 ( {( 1 + δ )}^{\frac{3}{2}} - 1 ) .$$

In this embodiment, the proof may be assumed to be powering Σᵢ₌₂^{N}^{ₗ}σᵢ² by two and applying a Cauchy-Schwartz inequality.

Theorem 1. Let F* denote the solution to equation (4). As shown above, in this embodiment, F* may be assumed to be decomposed as F*=UΣVT. Additionally, it may be assumed that μₘᵢₙ may exist such that, if μ<μₘᵢₙ in equation (4).

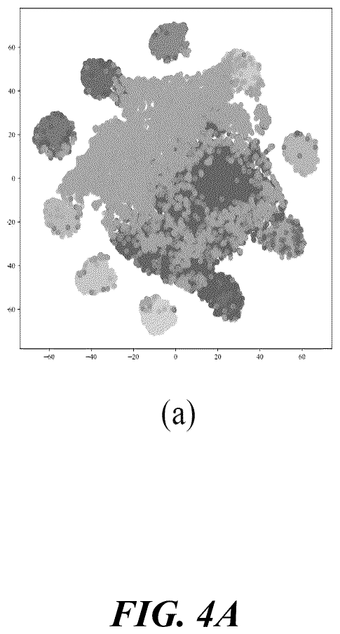

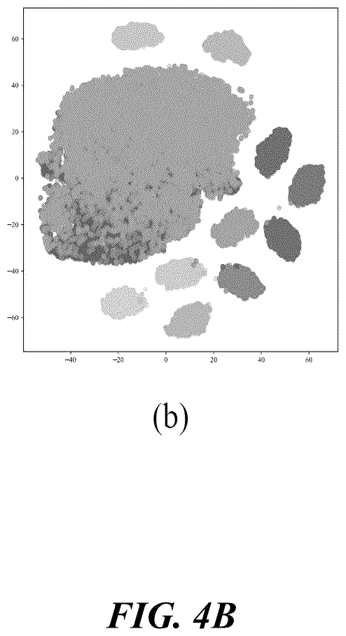

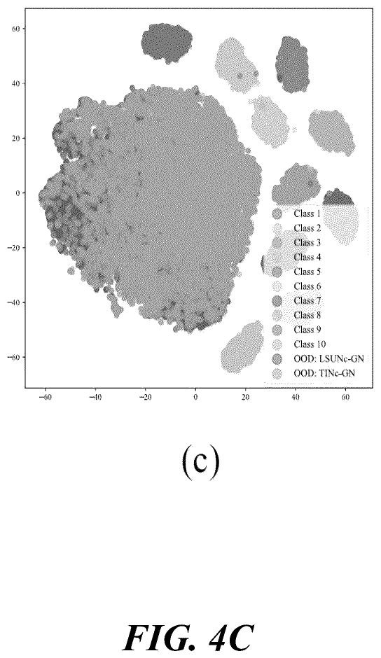

Another feature of the present disclosure is that the uni-dimensional embedding of the OOD detection system may be robust in its OOD detection. In this embodiment, an invariance and/or the stability of the first singular vector for the features extracted for samples may be generated from at least one class, via the at least one processor. As such, the at least one processor may be configured to transmit the extracted samples, such that the extracted samples may be visualized on the display device associated with the computing device communicatively coupled to the robust OOD detection system. As such, the robust OOD detection system may show that using the contrastive loss along certain values of μ regularize the logit loss, the dominance of the first eigenvector of the adjacency matrix may also be inherited to the first singular vector of the F, which functionality may depend on the stability and dominance of the first singular vector. As shown in FIG. 4A, FIG. 4B, and FIG. 4C, in this manner, most of the information included in the samples belonging to at least one class, may be reflected in uni-dimensional projections, via the display device communicatively coupled to the robust OOD detection system.

In an embodiment, if the dominance is assumed to be held for at least the first singular value of each class data, the contrastive learning may therefore split at least the first singular value of each class data by summarizing the class-wise data into unidimensional separate representations. As such, as shown in FIG. 2, the V matrix may be used to orthogonalize and rotate the uni-dimensional vectors obtained by contrastive learning to match the pre-defined orthogonal set of vectors wₗ as much as possible.

Proof 2. A is Hermitian. Therefore, in an embodiment, it may be decomposed as A=QΛQ^{T}. As such, in this embodiment, the solution which may be set to minimize [symbol] _{CL} is written as:

$$S = \{ Q {Λ}^{\frac{1}{2}} {V}^{T} : ∀ orthonormal matrix V \} ( {λ}_{i} = {Λ}_{i i} = {σ}_{i}^{2} ) .$$

In the equation, shown above, “L₁” and “L₂” be the minima for equation (4) obtained on the sets, “S” and “S^{C}” (e.g., the complementary set of S), respectively. L₁ equals μₘᵢₙF ∈S [symbol] _{LL}(F) as the first loss is 0 for elements in S. For L₂, S^{C} may be partitioned into two sets S₁^{c} and where elements in S₁^{c} may set [symbol] _{LL} to zero and elements in S₂^{c} may yield non-zero values for [symbol] _{LL}. Therefore, L₂ may be defined as the minimum of the two partition's minima. The equation showing how L₂ may be defined as the minimum may be calculated is provided below, as follows:

$${L}_{2} = min \{ {\underbrace{{min}_{F {∈}_{1}^{c}} {ℒ}_{C L} ( F )}}_{LHS} , {\underbrace{{min {ℒ}_{C L}}_{F ∈ {S}_{2}^{c}} ( F ) + {μℒ}_{L L} ( F )}}_{R H S} \} \qquad ( 5 )$$

Accordingly, as shown in the equation, above, for a small value μ, L₂ equals the RHS. Furthermore, the LHS value be denoted with m1, where m1>0, since S and S₁^{c} are disjoint sets with no sharing boundaries. The RHS in equation (5) may be composed of two parts. The first part may be arbitrarily small because although S and S₂^{c} are disjoint sets, S and S₂^{c} may still be connected, via sharing boundaries. For example, any small perturbation in Λ eigenvalues drags a matrix from S into S₂^{c}, however, in this example, S and S₂^{c} are infinitesimally close due to the continuity property. The second term can also be shrunk with an arbitrarily small choice of

$$μ = {μ}_{min} = \frac{{m}_{1}}{{ℒ}_{L L} ( \tilde{F} )}$$

which may guarantee that the RHS takes the minimum in equation (5), where

$$\tilde{F} = {arg min}_{F ∈ {S}_{2}^{c}} {ℒ}_{C L} ( F ) .$$

Therefore, for μ<μₘᵢₙ, the minimum objective value in equation (4) (min{L₁,L₂}) may be defined as follows:

$$min \{ {min}_{F ∈ S} {ℒ}_{C L} ( F ) + {μℒ}_{L L} ( F ) , min {{μℒ}_{L L}}_{F ∈ S} ( F ) \} .$$

In this embodiment, F* may inherit the dominance of first eigenvalue from A. For example, if the solution is RHS in equation (5), since the solution lies on S in that case and may then be expressed as

$$Q {Λ}^{\frac{1}{2}} {V}^{T} ,$$

F* may then inherit the property as defined and shown in Lemma 1.

Furthermore, in an embodiment, where min{L₁,L₂} may be obtained by the RHS via explicitly writing when LHS>RHS, the minimizers for the RHS and LHS may be assumed to differ in a matrix R. As such, F* may be denoted as the minimizer for RHS. Then, the minimizer of LHS may be defined as F*+R. In this manner, the equation defining LHS may be written as follows:

$$L H S = {‖ A - ( {F}^{*} = T ) {( {F}^{*} + R )}^{T} ‖}_{F}^{2} + μ {‖ {W}^{T} {F}^{*} + {W}^{T} R - Y ‖}_{F}^{2}$$

$$L H S = {‖ {\underbrace{A - {F}^{*} {F}^{{*}^{T}}}}_{0} - {\underbrace{( {F}^{*} {R}^{T} + R {F}^{{*}^{T}} + R {R}^{T} )}}_{E} ‖}_{F}^{2} + μ {‖ {W}^{T} {F}^{*} - Y + {W}^{T} R ‖}_{F}^{2}$$

$$L H S = {‖ E ‖}_{F}^{2} + μ {‖ {W}^{T} {F}^{*} - Y ‖}_{F}^{2} + μ {‖ {W}^{T} R ‖}_{F}^{2} + 2 μ 〈 {W}^{T} {F}^{*} - Y , {W}^{T} R 〉$$

As shown in the equation above, the inner product of two matrices A, B ((A,B)) may be defined as Tr(AB^{T}). Furthermore, the RHS in equation (5) may equate μ∥WTF*−Y∥₂² as F* is its minimizer and the loss has only the logit loss term. Thus, the condition LHS>RHS may then be reduced to ∥E∥_{F}²+μ∥WTR∥_{F}²+2μ(WTF*−Y,WTR)>0.

Additionally, in this embodiment, the matrix W may be predefined to be an orthonormal matrix, however, multiplying it by R does not change the Frobenius norm. As such, the condition may then be reduced to ∥E∥_{f}²+μ∥R∥_{F}²>2μ(Y−WTF*,WTR). Moreover, in order to establish this bound, in an embodiment, the Cauchy-Schwartz inequality (hereinafter “C-S”) and the Inequality of Arithmetic and Geometric Means (hereinafter “AM-GM”) may be used to obtain the upper bound for the inner product. For example, the sufficient condition holds true if it is established for the obtained upper bound (e.g., tighter inequality). The equation showing how the C-S and AM-GM inequalities may be applied as follows:

$$- {W}^{T} {F}^{*} , {W}^{T} R \begin{matrix}C - S \\ \vec{\leq }\end{matrix} {‖ Y - {W}^{T} {F}^{*} ‖}_{F} {‖ {W}^{T} R ‖}_{F} = {‖ Y - {W}^{T} {F}^{*} ‖}_{F} {‖ R ‖}_{F} \begin{matrix}A M - G M \\ \vec{\leq }\end{matrix} \frac{1}{2} {‖ Y - {W}^{T} {F}^{*} ‖}_{F}^{2} + \frac{1}{2} {‖ R ‖}_{F}^{2}$$

Substituting the equation, as shown above, for the inner product in order to establish a tighter inequality may provide ∥E∥_{F}²+μ∥R∥_{F}²>μ∥Y−W^{T}F*∥_{F}²+μ∥R∥_{F}², such that the inequality may be reduced to ∥E∥_{F}²>μ∥Y−w^{T}F*∥_{F}².

For example, as the matrix of all zeros (i.e., “0” ∈S), inserting “0” for F leads to a trivial upper bound for the minimum obtained over F ∈S, i.e., ∥Y−W^{T}F*∥_{F}² is upper bounded with ∥Y∥_{F}². Therefore, finding a condition for ∥E∥_{f}²>μₘᵢₙ∥Y∥_{F}² may guarantee the desired condition is satisfied. If ∥E∥_{F}²>μₘᵢₙ∥Y∥_{F}² is met, the solution may lie in S and RHS obtains the minimum, validating Lemma 1 for F*.

Accordingly, in an embodiment, if the solution lies in S₂^{c} and is attained from the LHS such that it contravenes the dominance of the first principal component of A, another feature of the present disclosure may detect a contradiction that the proper choice for μ avoids LHS to be less than the RHS in equation (5). To this end, if R is to perturb the solution F* such that the first principal component may not be prominent, for R+F*, Σᵢ₌₂^{N}^{ₗ}σᵢ²>Δ+α may be equated for some positive α, such that the condition stated in the Theorem 1 may be violated. As such, at least one singular value of F* +R may be calculated, for which

$${σ}_{r} > \sqrt{\frac{Δ + α}{{N}_{l} - 1}} = \sqrt{\frac{α}{{N}_{l} - 1}} + O ( \sqrt[4]{δ} ) .$$

Additionally, F* may inherit the square root of eigenvalues of A, according to Lemma 1 and using Taylor series expansion,

$${σ}^{2} ( R ) > \sqrt{\frac{α}{{N}_{l} - 1}} + O ( \sqrt[4]{δ} ) .$$

A variable “E” may be defined as a symmetric matrix and therefore it has eigenvalue decomposition, such that the inequality may be written as follows:

$${‖ E ‖}_{F}^{2} \geq {λ}_{r}^{2} = {λ}_{r}^{2} ( R {R}^{T} + R {F}^{{*}^{T}} + {F}^{*} {R}^{T} ) = {λ}_{r}^{2} ( R {R}^{T} ) + O ( δ ) > \frac{{α}^{2}}{{( {N}_{l} - 1 )}^{2}} + O ( δ )$$

As defined in the equation above, by defining ∥Y∥_{F}²=Nₗ², if

$$μ < \frac{{α}^{2}}{{N}_{l}^{4}} ,$$

the condition for RHS<LHS is met. For example, according to Lemma 1 and the previous bound found for

$${μ}_{min} < min \{ \frac{{α}^{2}}{{N}_{l}^{4}} , \frac{{m}_{1}}{{ℒ}_{L L} ( \tilde{F} )} \} ,$$

the solution should be

$${F}^{*} = Q {Λ}^{\frac{1}{2}} {V}^{T} .$$

In addition, in an embodiment, the robust OOD detection system may comprise at least one generative AI model, such as a Generative Adversarial Network (hereinafter “GANs”), a Variational Autoencoder (hereinafter “VAEs”), and/or a Diffusion Model. In this embodiment, the robust OOD detection system may be configured to ensure that the generative model does not produce unrealistic and/or nonsensical samples. In this manner, via the at least one generative AI model, the robust OOD detection system may identify samples outside of its training data, such that the at least one generative AI model may avoid generating potentially harmful and/or misleading outputs. Additionally, in this embodiment, the robust OOD detection system may be configured to display each identified and/or unidentified samples on the display device communicatively coupled to the computing device associated with the robust OOD detection system. In some embodiments the identified and/or unidentified samples may be displayed in graphical and/or table format.

Additionally, in an embodiment, the robust OOD detection system comprising the at least one generative AI model OOD may be configured to quantify an uncertainty score, with respect to the samples the robust OOD detection system may generate. As such, when the model encounters inputs that are far from the training distribution, the robust OOD detection system may be configured to transmit, via the at least one processor, a signal indicative of a high uncertainty, preventing the use of unreliable samples in applications. In this same manner, when the model encounters inputs that are similar and/or close to the training distribution, the robust OOD detection system may be configured to transmit, via the at least one processor, a signal indicative of a low uncertainty, allowing the use of reliable samples in applications.

Moreover, in this embodiment, within real-world scenarios, the at least one generative AI model of the robust OOD detection system may encounter at least one input that may be corrupted, noisy, and/or unusual. In this manner, the robust OOD detection system may be configured to identify such inputs and/or prevent generating erroneous outputs. In addition, in this embodiment, the generative AI model of the robust OOD detection system may be configured to be trained on at least one dataset, such that the at least one generative AI model of the robust OOD detection system may be used in a different but related domain. As such, the robust OOD detection system may be configured to understand when it is out of its domain and/or the robust OOD detection system, via the at least one processor, may be configured to transmit a notification indicative of a guided effort for domain adaptation and/or transfer learning.

In an embodiment, the robust OOD detection system may be configured to filter at least one data generation process. As such, the OOD detection system may determine, via the at least one generative AI model, that only valid, relevant, and/or meaningful samples are produced and/or may be used in any downstream application. In this manner, the robust OOD detection system may be communicatively coupled to the at least one downstream and/or upstream application. Accordingly, in some embodiments, the robust OOD detection system may transmit at least one electrical signal to the at least one downstream and/or upstream application, via the at least one API. In addition, the robust OOD detection system, via the at least one generative AI model, may detect and/or help identify at least one adversarial sample within the dataset. In this embodiment, when the at least one generative AI model determines at least one adversarial sample, the robust OOD detection system, via the at least one processor, may be configured to prevent the model from making incorrect predictions and/or displaying the prediction on the display device.

In addition, in some embodiments, in at least one scenario where anomalies need to be detected, the robust OOD detection system may identify the at least one input which may deviate significantly from the majority of the data within the dataset. In this manner, based on the at least one upstream and/or downstream application, the robust OOD detection system may be configured to remove the at least one input which may deviate significantly form the majority of the data within the dataset. Overall, by incorporating OOD detection, via the robust OOD detection system, in the at least one generative AI model enhances their safety, reliability, and/or adaptability, making them more suitable for real-world applications across various domains.

In some embodiments, the robust OOD detection system may be configured to input at least one benchmark dataset, such that the OOD generalization capabilities of the robust OOD detection system may be evaluated, retrained, and/or optimized for the at least one generative AI model. As such, standardized datasets help researchers compare their methods and drive progress in the field.

Additionally, the robust OOD detection system comprising the at least one generative AI model may present several promising market opportunities due to its potential to address critical challenges in the field of AI and data generation. Some of the greatest market opportunities for this invention include, but are not limited to: (1) Healthcare and Medical Imaging, (2) Entertainment and/or Creativity; (3) AI Research and/or Development; and/or (4) Regulatory Compliance and/or Ethical AI. Medical imaging and/or diagnosis require highly accurate and/or reliable AI models. In some embodiments, the robust OOD detection system may be configured to aid in detecting abnormal and/or atypical cases, helping healthcare professionals make more informed decisions and improving patient outcomes.

In this same manner, within the entertainment industry, the robust OOD detection system, via the at least one processor, may be configured to be leveraged to generate novel and/or creative content, such as realistic characters, scenes, and/or music, expanding the possibilities for content creation. Moreover, in these other embodiments, the robust OOD detection system may benefit researchers and/or developers by providing a standardized and reliable tool for evaluating and improving generative models, accelerating advancements in the field of AI.

Finally, with increasing regulations around AI and/or data usage, in some embodiments, the robust OOD Detection system may contribute to ensuring compliance with ethical guidelines and/or privacy standards, enhancing the responsible deployment of AI technologies. Overall, robust OOD detection system has the potential to impact a wide range of industries and/or applications, driving innovation, and/or creating new opportunities for businesses and developers in the AI ecosystem.

The following examples are provided for the purpose of exemplification and are not p intended to be limiting.

### EXAMPLES

### Example 1

Robust OOD Detection System against Corrupted ID and/or OOD Test Samples

In experiments, CIFAR-10 and CIFAR-100 were used as ID datasets and 7 OOD datasets. The OOD datasets utilized are TinylmageNet-crop (TINc), TinylmageNetresize (TINr) [5], LSUN-resize (LSUN-r) [35], Places [39], Textures [4], SVHN and iSUN [31]. For an architecture, WideResNet was deployed with depth and width equal to 40 and 2, respectively, as an encoder in the experiments. However, the penultimate layer has been modified as compared to the baseline architecture as shown in FIGS. 2A-2D.

As in [6] and [29], the OOD detection performance of the robust OOD detection system (hereinafter “ROOD”) is evaluated using the following metrics: (i) FPR95 indicates the false positive rate (FPR) at 95% true positive rate (TPR) and (ii) AUROC, which is defined as the Area Under the Receiver Operating Characteristic curve. As ROOD is a probabilistic approach, sampling is performed on the ID and OOD data during the test time to ensure the probabilistic settings. Monte Carlo sampling is employed to estimate p(δ^{t}≤δ^{th}) for OOD detection, where δ^{Th} is the uncertainty score threshold calculated using training samples. During inference, 50 samples are drawn for a given sample, t. The evaluation metrics are then applied on ID test data and OOD data using the estimated δ^{Th} to calculate the difference in the feature space.

The performance of the robust OOD detection system (“ROOD”) is provided in TABLE 1 and TABLE 2 for CIFAR-10 and CIFAR-100, respectively. The present disclosure achieves an FPR95 improvement of 21.66%, as compared to the most recently reported SOTA [6], on CIFAR-10. Furthermore, similar performance gains are obtained for the CIFAR-100 dataset as well. For the ROOD, the model is first pre-trained using self-supervised adversarial contrastive learning [16]. The model is then fine-tuned following the training settings in [38].

TABLE 1

| | OOD Datasets | | | | | | | |
|---|---|---|---|---|---|---|---|---|
| | SVHN | | iSUN | | LSUNr | | TINc | |
| | | AUROC | FPR95 | AUROC | FPR95 | AUROC | FPR95 | AUROC |
| ↓ | FPR95 | ↑ | ↓ | ↑ | ↓ | ↑ | ↓ | ↑ |
| MSP [10] | 48.49 | 91.89 | 56.03 | 89.83 | 52.15 | 91.37 | 53.15 | 87.33 |
| ODIN [22] | 33.55 | 91.96 | 32.05 | 93.50 | 26.52 | 94.57 | 36.75 | 89.20 |
| Mahalanobis [21] | 12.89 | 97.62 | 44.18 | 92.66 | 42.62 | 93.23 | 42.75 | 88.85 |
| Energy [23] | 35.59 | 90.96 | 33.68 | 92.62 | 27.58 | 94.24 | 35.69 | 89.05 |
| OE [11] | 4.36 | 98.63 | 6.32 | 98.85 | 5.59 | 98.94 | 13.45 | 96.44 |
| VOS [6] | 8.65 | 98.51 | 7.56 | 98.71 | 14.62 | 97.18 | 11.76 | 97.58 |
| FS [37] | 24.71 | 95.31 | 17.41 | 96.61 | 4.84 | 96.28 | 12.45 | 97.83 |
| ROOD | 1.82 | 99.63 | 4.07 | 99.32 | 4.49 | 99.25 | 10.29 | 98.10 |

| | OOD Datasets | | | | | |
|---|---|---|---|---|---|---|
| | TINr | | Places | | Textures | |
| | FPR95 | AUROC | FPR95 | AUROC | FPR95 | AUROC |
| ↓ | ↓ | ↑ | ↑ | ↓ | ↑ | ↓ |
| MSP [10] | 54.24 | 79.35 | 59.48 | 88.20 | 59.28 | 88.50 |
| ODIN [22] | 49.15 | 81.64 | 57.40 | 84.49 | 49.12 | 84.97 |
| Mahalanobis [21] | 52.25 | 80.33 | 92.38 | 33.06 | 15.00 | 97.33 |
| Energy [23] | 50.45 | 81.33 | 40.14 | 89.89 | 52.79 | 85.22 |
| OE [11] | 15.67 | 96.78 | 19.07 | 96.16 | 12.94 | 97.73 |
| VOS [6] | 28.08 | 94.26 | 37.61 | 90.42 | 47.09 | 86.64 |
| FS [37] | 9.65 | 97.95 | 11.56 | 96.42 | 5.55 | 98.64 |
| ROOD | 6.30 | 99.0 | 9.59 | 98.47 | 3.87 | 99.43 |

TABLE 2

| | OOD Datasets | | | | | | | |
|---|---|---|---|---|---|---|---|---|
| | SVHN | | iSUN | | LSUNr | | TINc | |
| | FPR95 | AUROC | FPR95 | AUROC | FPR95 | AUROC | FPR95 | AUROC |
| | ↓ | ↑ | ↓ | ↑ | ↓ | ↑ | ↓ | ↑ |
| MSP [10] | 84.59 | 71.44 | 82.80 | 75.46 | 82.42 | 75.38 | 69.82 | 79.77 |
| ODIN [22] | 84.66 | 67.26 | 68.51 | 82.69 | 71.96 | 81.82 | 45.55 | 87.77 |
| Mahalanobis [21] | 57.52 | 86.01 | 26.10 | 94.58 | 21.23 | 96.00 | 43.45 | 86.65 |
| Energy [23] | 85.52 | 73.99 | 81.04 | 78.91 | 79.47 | 79.23 | 68.85 | 78.85 |
| OE [11] | 65.91 | 86.66 | 72.39 | 78.61 | 69.36 | 79.71 | 46.75 | 85.45 |
| VOS [6] | 65.56 | 87.86 | 74.65 | 82.12 | 70.58 | 83.76 | 47.16 | 90.98 |
| FS [37] | 22.75 | 94.33 | 45.45 | 85.61 | 40.52 | 87.21 | 11.76 | 97.58 |
| ROOD | 19.89 | 95.76 | 39.79 | 88.40 | 36.61 | 89.73 | 44.42 | 85.95 |

| | OOD Datasets | | | | | |
|---|---|---|---|---|---|---|
| | TINr | | Places | | Textures | |
| | FPR95 | AUROC | FPR95 | AUROC | FPR95 | AUROC |
| | ↓ | ↑ | ↑ | ↓ | ↑ | ↓ |
| MSP [10] | 79.95 | 72.36 | 82.84 | 73.78 | 83.29 | 73.34 |
| ODIN [22] | 57.34 | 80.88 | 87.88 | 71.63 | 49.12 | 84.97 |
| Mahalanobis [21] | 44.45 | 85.68 | 88.83 | 67.87 | 39.39 | 90.57 |
| Energy [23] | 77.65 | 74.56 | 40.14 | 89.89 | 52.79 | 85.22 |
| OE [11] | 78.76 | 75.89 | 57.92 | 85.78 | 61.11 | 84.56 |
| VOS [6] | 73.78 | 81.58 | 84.45 | 72.20 | 82.43 | 76.95 |
| FS [37] | 44.08 | 86.26 | 47.61 | 88.42 | 47.09 | 86.64 |
| ROOD | 42.56 | 87.67 | 41.72 | 89.10 | 24.64 | 94.14 |

In this section, extensive ablation studies are conducted to evaluate the robustness of ROOD against corrupted ID and OOD test samples. Firstly, the 14 corruptions in [9] were applied on OOD data to generate corrupted OOD (OOD-C). Corruptions introduced can be benign or destructive based on their intensity which is defined by their severity level. To do comprehensive evaluations, 5 severity levels of the corruptions are infused. By introducing such corruptions in OOD datasets, the calculated mean detection error for both CIFAR-10 and CIFAR-100 is 0%, which highlights the inherit property of ROOD that it shifts perturbed OOD features further away from the ID as shown in t-SNE plots in FIG. 4A, FIG. 4B, and FIG. 4C, which show that perturbing OOD improves the ROOD' s performance. As such, FIG. 4A depicts a t-SNE plot with features extracted from the baseline model with a corruption severity level of 1. Secondly, corruptions [9] were introduced in the ID test data while keeping OOD data clean during testing. The performance of ROOD on corrupted CIFAR-100 (CIFAR100-C) has been compared with VOS [6] in TABLE 3. Lastly, the classification accuracy of the proposed method was compared with the baseline WideResNet model on clean and corrupted ID test samples in TABLE 4. Accordingly, the performance of ROOD on the corrupted CIFAR-100 (CIFAR100-C) was plotted on t-SNE plots. As such, FIG. 4B depicts substantial improvement was the features were extracted using ROOD with corruption severity level 1, while, the t-SNE plot, as shown in FIG. 4C, provides the clearest distinction between OOD and each class, as FIG. 4C plots the features as extracted from the ROOD with corruption severity level 5. ROOD has improved accuracy on corrupted ID test data as compared to the baseline with a negligible drop on classification accuracy of clean ID test data.

TABLE 3

| | | | | | | | | | | | | | | Digital | | |
|---|---|---|---|---|---|---|---|---|---|---|---|---|---|---|---|---|
| | | | | Noise | | | Blur | | | Weather | | | | Elastic | | |
| Dataset | Method | Clean | Gauss | Shot | Impulse | Defocus | Motion | Zoom | Snow | Frost | Fog | Bright | Cont. | Pixel | | JPEG |
| ↓FPR95 | VOS | 66.79 | 72.55 | 76.95 | 90.36 | 84.50 | 83.62 | 84.56 | 87.0 | 83.34 | 83.84 | 86.11 | 86.67 | 85.81 | 89.58 | 89.25 |
| | ROOD | 39.76 | 67.91 | 65.42 | 65.53 | 49.51 | 71.81 | 55.87 | 53.92 | 59.84 | 52.23 | 48.39 | 52.98 | 57.31 | 55.42 | 66.47 |
| ↑AUROC | VOS | 81.9 | 74.26 | 72.90 | 60.00 | 68.35 | 69.83 | 68.55 | 65.31 | 68.14 | 68.50 | 66.54 | 66.82 | 66.98 | 61.18 | 62.38 |
| | ROOD | 88.1 | 77.18 | 78.40 | 78.41 | 84.70 | 74.64 | 82.42 | 83.50 | 80.60 | 83.85 | 85.54 | 83.44 | 81.91 | 83.11 | 78.19 |

TABLE 4

| | | | | | | | | | | | | | | Digital | | |
|---|---|---|---|---|---|---|---|---|---|---|---|---|---|---|---|---|
| | | | | Noise | | | Blur | | | Weather | | | | Elastic | | |
| Dataset | Method | Clean | Gauss | Shot | Impulse | Defocus | Motion | Zoom | Snow | Frost | Fog | Bright | Cont. | Pixel | | JPEG |
| CIFAR10-C | Baseline | 94.52 | 46.54 | 57.72 | 56.45 | 69.15 | 62.98 | 58.85 | 74.88 | 72.18 | 84.26 | 92.19 | 75.14 | 74.31 | 68.27 | 77.34 |
| | ROOD | 94.45 | 49.63 | 59.89 | 55.62 | 69.77 | 64.81 | 61.79 | 78.59 | 74.48 | 86.56 | 93.08 | 73.37 | 75.49 | 70.79 | 80.12 |
| CIFAR100-C | Baseline | 72.35 | 18.80 | 26.56 | 25.56 | 49.80 | 40.45 | 39.37 | 45.38 | 42.62 | 56.40 | 69.14 | 52.87 | 48.32 | 40.70 | 46.11 |
| | ROOD | 72.20 | 18.40 | 27.13 | 26.25 | 50.32 | 41.82 | 40.40 | 46.25 | 43.46 | 57.13 | 70.0 | 51.81 | 49.05 | 40.86 | 47.62 |

In-distribution features may be aligned in a narrow region of the latent space using contrastive pre-training and uni-dimensional feature mapping. With such compact mapping, a class representative feature first singular vector may then be calculated from the features for each in-distribution class. The cosine similarity between these computed singular vectors and an extracted feature vector of the test sample may then be estimated to perform OOD test. As such, the present disclosure has been shown to achieve highly accurate OOD detection results on large-scale datasets and image classification benchmarks.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

[1] Victor Besnier, Andrei Bursuc, David Picard, and Alexandre Briot. Triggering failures: Out-of-distribution detection by learning from local adversarial attacks in semantic segmentation. In Proceedings of the IEEE/CVF International Conference on Computer Vision, pages 15701-15710,2021.

[2] Jiefeng Chen, Yixuan Li, XiWu, Yingyu Liang, and Somesh Jha. Atom: Robustifying out-of-distribution detection using outlier mining. In Joint European Conference on Machine Learning and Knowledge Discovery in Databases, pages 430-445. Springer, 2021.

[3] Tianlong Chen, Sijia Liu, Shiyu Chang, Yu Cheng, Lisa Amini, and Zhangyang Wang. Adversarial robustness: From self-supervised pre-training to fine-tuning. In Proceedings of the IEEE/CVF Conference on Computer Vision and Pattern Recognition, pages 699-708,2020.

[4] Mircea Cimpoi, Subhransu Maji, Iasonas Kokkinos, Sammy Mohamed, and Andrea Vedaldi. Describing textures in the wild. In Proceedings of the IEEE conference on computer vision and pattern recognition, pages 3606-3613,2014.

[5] Jia Deng, Wei Dong, Richard Socher, Li-Jia Li, Kai Li, and Li Fei-Fei. Imagenet: A large-scale hierarchical image database. In 2009 IEEE conference on computer vision and pattern recognition, pages 248-255. Ieee, 2009.

[6] Xuefeng Du, Zhaoning Wang, Mu Cai, and Yixuan Li. Vos: Learning what you don't know by virtual outlier synthesis. arXiv preprint arXiv:2202.01197,2022.

[7] Angelos Filos, Panagiotis Tigkas, Rowan McAllister, Nicholas Rhinehart, Sergey Levine, and Yarin Gal. Can autonomous vehicles identify, recover from, and adapt to distribution shifts? In International Conference on Machine Learning, pages 3145-3153. PMLR, 2020.

[8] Jeff Z HaoChen, ColinWei, Adrien Gaidon, and Tengyu Ma. Provable guarantees for self-supervised deep learning with spectral contrastive loss. Advances in Neural Information Processing Systems, 34, 2021.

[9] Dan Hendrycks and Thomas Dietterich. Benchmarking neural network robustness to common corruptions and perturbations. Proceedings of the International Conference on Learning Representations, 2019.

[10] Dan Hendrycks and Kevin Gimpel. A baseline for detecting misclassified and out-of-distribution examples in neural networks. Proceedings of International Conference on Learning Representations, 2017.

[11] Dan Hendrycks, Mantas Mazeika, and Thomas Dietterich. Deep anomaly detection with outlier exposure. arXiv preprint arXiv:1812.04606, 2018.

[12] Chih-Hui Ho and Nuno Nvasconcelos. Contrastive learning with adversarial examples. Advances in Neural Information Processing Systems, 33:17081-17093, 2020.

[13] Yen-Chang Hsu, Yilin Shen, Hongxia Jin, and Zsolt Kira. Generalized odin: Detecting out-of-distribution image without learning from out-of-distribution data. In Proceedings of the IEEE/CVF Conference on Computer Vision and Pattern Recognition, pages 10951-10960, 2020.

[14] Rui Huang and Yixuan Li. Mos: Towards scaling out-of-distribution detection for large semantic space. In Proceedings of the IEEE/CVF Conference on Computer Vision and Pattern Recognition, pages 8710-8719, 2021.

[15] Taewon Jeong and Heeyoung Kim. Ood-maml: Meta learning for few-shot out-of-distribution detection and classification. Advances in Neural Information Processing Systems, 33, 2020.

[16] Ziyu Jiang, Tianlong Chen, Ting Chen, and Zhangyang Wang. Robust pre-training by adversarial contrastive learning. Advances in Neural Information Processing Systems, 33:16199-16210, 2020.

[17] Nazmul Karim, Umar Khalid, Nick Meeker, and Sarinda Samarasinghe. Adversarial training for face recognition systems using contrastive adversarial learning and triplet loss fine-tuning, 2021.

[18] Minseon Kim, Jihoon Tack, and Sung Ju Hwang. Adversarial self-supervised contrastive learning. Advances in Neural Information Processing Systems, 33:2983-2994, 2020.1, 3

[19] Alex Krizhevsky, Geoffrey Hinton, et al. Learning multiple layers of features from tiny images. 2009.

[20] Kimin Lee, Honglak Lee, Kibok Lee, and Jinwoo Shin. Training confidence-calibrated classifiers for detecting out-of-distribution samples. arXiv preprint arXiv:1711.09325, 2017.

[21] Kimin Lee, Kibok Lee, Honglak Lee, and Jinwoo Shin. A simple unified framework for detecting out-of-distribution samples and adversarial attacks. Advances in neural information processing systems, 31, 2018.

[22] Shiyu Liang, Yixuan Li, and Rayadurgam Srikant. Enhancing the reliability of out-of-distribution image detection in neural networks. arXiv preprint arXiv:1706.02690, 2017.

[23] Weitang Liu, Xiaoyun Wang, John Owens, and Yixuan Li. Energy-based out-of-distribution detection. Advances in Neural Information Processing Systems (NeurIPS), 2020.

[24] Siyu Luan, Zonghua Gu, Leonid B Freidovich, Lili Jiang, and Qingling Zhao. Out-of-distribution detection for deep neural networks with isolation forest and local outlier factor. IEEE Access, 9:132980-132989, 2021.

[25] Yuval Netzer, Tao Wang, Adam Coates, Alessandro Bissacco, Bo Wu, and Andrew Y Ng. Reading digits in natural images with unsupervised feature learning. 2011.

[26] Stanislav Pidhorskyi, Ranya Almohsen, and Gianfranco Doretto. Generative probabilistic novelty detection with adversarial autoencoders. Advances in neural information processing systems, 31, 2018.

[27] Andrew M Saxe, James L McClelland, and Surya Ganguli. Exact solutions to the nonlinear dynamics of learning in deep linear neural networks. arXiv preprint arXiv:1312.6120, 2013.

[28] Gabi Shalev, Yossi Adi, and Joseph Keshet. Out-of-distribution detection using multiple semantic label representations. Advances in Neural Information Processing Systems, 31, 2018.

[29] Yiyou Sun, Chuan Guo, and Yixuan Li. React: Out-of-distribution detection with rectified activations. Advances in Neural Information Processing Systems, 34, 2021.

[30] Apoory Vyas, Nataraj Jammalamadaka, Xia Zhu, Dipankar Das, Bharat Kaul, and Theodore L Willke. Out-of-distribution detection using an ensemble of self-supervised leave-out classifiers. In Proceedings of the European Conference on Computer Vision (ECCV), pages 550-564, 2018. 1

[31] Pingmei Xu, Krista A Ehinger, Yinda Zhang, Adam Finkelstein, Sanjeev R Kulkarni, and Jianxiong Xiao. Turkergaze: Crowdsourcing saliency with webcam based eye tracking. arXiv preprint arXiv:1504.06755, 2015. 5

[32] Yihao Xue, Kyle Whitecross, and Baharan Mirzasoleiman. Investigating why contrastive learning benefits robustness against label noise, 2022. 1, 3

[33] Mingyang Yi, Lu Hou, Jiacheng Sun, Lifeng Shang, Xin Jiang, Qun Liu, and Zhi-Ming Ma. Improved OOD generalization via adversarial training and pre-training, 2021. 1

[34] Ryota Yoshihashi, Wen Shao, Rei Kawakami, Shaodi You, Makoto Iida, and Takeshi Naemura. Classification reconstruction learning for open-set recognition. In Proceedings of the IEEE/CVF Conference on Computer Vision and Pattern Recognition, pages 4016-4025, 2019. 1

[35] Fisher Yu, Ari Seff, Yinda Zhang, Shuran Song, Thomas Funkhouser, and Jianxiong Xiao. Lsun: Construction of a large-scale image dataset using deep learning with humans in the loop. arXiv preprint arXiv:1506.03365, 2015. 5

[36] Qing Yu and Kiyoharu Aizawa. Unsupervised out-of-distribution detection by maximum classifier discrepancy. In Proceedings of the IEEE/CVF International Conference on Computer Vision, pages 9518-9526, 2019. 1

[37] Alireza Zaeemzadeh, Niccol'o Bisagno, Zeno Sambugaro, Nicola Conci, Nazanin Rahnavard, and Mubarak Shah. Out-of-distribution detection using union of 1-dimensional subspaces. In Proceedings of the IEEE/CVF Conference on Computer Vision and Pattern Recognition, pages 9452— 9461, 2021. 1, 6

[38] Sergey Zagoruyko and Nikos Komodakis. Wide residual networks. arXiv preprint arXiv:1605.07146, 2016. 5

[39] Bolei Zhou, Agata Lapedriza, Aditya Khosla, Aude Oliva, and Antonio Torralba. Places: A 10 million image database for scene recognition. IEEE transactions on pattern analysis and machine intelligence, 40(6):1452-1464, 2017.

[40] Chen, T., Kornblith, S., Norouzi, M. and Hinton, G., 2020, November. A simple framework for contrastive learning of visual representations. In International conference on machine learning (pp. 1597-1607). PMLR.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A method of detecting an unknown class data set within a largescale dataset, the method comprising:
loading, into a memory of a computing device, a predetermined largescale dataset, wherein the largescale dataset comprises a plurality of in-distribution (hereinafter “ID”) class data;
pre-training, via at least one processor of the computing device, the predetermined largescale dataset, wherein the plurality of ID class data is augmented with the adversarial perturbations;
calculating, via the at least one processor of the computing device, at least one singular vector for the plurality of augmented ID class data, thereby establishing at least one ID class associated with the plurality of augmented ID class data;
comparing, via the at least one processor of the computing device, a largescale dataset comprising a plurality of out-of-distribution (hereinafter “OOD”) class data with the at least one singular vector; and
automatically displaying, an uncertainty score of the largescale dataset on a display device associated with the computing device by:
based on a determination that the at least one datapoint of the plurality of OOD class data matches the at least one singular vector, labeling, recording, or both, in real-time, the at least one datapoint into the at least one ID class; and
based on a determination that the at least one datapoint of the plurality of OOD class data does not match the at least one singular vector, labeling recording, or both, in real-time, the at least one datapoint into the at least one new OOD category.

2. The method of claim 1, wherein the step of calculating the at least one singular vector further comprises, determining the at least one singular vector comprising the majority of augmented ID class data.

3. The method of claim 2, wherein the plurality of augmented ID class data is inputted into a singular value decomposition algorithm.

4. The method of claim 2, wherein when comparing the largescale dataset comprising the plurality of OOD class data with the at least one singular vector, the at least one singular vector is the at least one singular vector comprising the majority of augmented ID class data.

5. The method of claim 1, wherein the step of comparing the largescale dataset comprising the plurality of OOD class data with the at least one singular vector further comprises, measuring the angular similarity between the plurality of OOD class data with the at least one singular vector.

6. The method of claim 1, wherein the largescale dataset is compared to the at least one singular vector using cosine similarity.

7. The method of claim 1, further comprising the step of, fine-tuning, via the at least one processor of the computing device, the at least one singular vector using cross-entropy loss.

8. The method of claim 7, wherein the at least one singular vector is orthogonal to at least one alternative singular vector.

9. The method of claim 7, wherein the step of fine-tuning the at least one singular vector further comprises, scaling, via the at least one processor of the computing device, the at least one singular vector with at least one sharpening function, thereby increasing a confidence in the at least one singular vector.

10. A dataset monitoring optimization system, the dataset monitoring optimization system comprising:
a computing device having at least one processor; and
a non-transitory computer-readable medium having stored thereon computing device-executable instructions that, when executed by the at least one processor, cause the computing device to perform operations comprising:
loading, into a memory of a computing device, a predetermined largescale dataset, wherein the largescale dataset comprises a plurality of in-distribution (hereinafter “ID”) class data;
pre-training, via at least one processor of the computing device, the predetermined largescale dataset, wherein the plurality of ID class data is augmented with the adversarial perturbations;
calculating, via the at least one processor of the computing device, at least one singular vector for the plurality of augmented ID class data, thereby establishing at least one ID class associated with the plurality of augmented ID class data;
comparing, via the at least one processor of the computing device, a largescale dataset comprising a plurality of out-of-distribution (hereinafter “OOD”) class data with the at least one singular vector; and
automatically displaying, an uncertainty score of the largescale dataset on a display device associated with the computing device by:
based on a determination that the at least one datapoint of the plurality of OOD class data matches the at least one singular vector, labeling, recording, or both, in real-time, the at least one datapoint into the at least one ID class; and
based on a determination that the at least one datapoint of the plurality of OOD class data does not match the at least one singular vector, labeling, recording, or both, in real-time, the at least one datapoint into the at least one new OOD category.

11. The system of claim 10, wherein the operating of calculating the at least one singular vector further comprises, determining the at least one singular vector comprising the majority of augmented ID class data.

12. The system of claim 11, wherein the plurality of augmented ID class data is inputted into a singular value decomposition algorithm.

13. The system of claim 11, wherein when comparing the largescale dataset comprising the plurality of OOD class data with the at least one singular vector, the at least one singular vector is the at least one singular vector comprising the majority of augmented ID class data.

14. The system of claim 10, wherein the operation of comparing the largescale dataset comprising the plurality of OOD class data with the at least one singular vector further comprises, measuring the angular similarity between the plurality of OOD class data with the at least one singular vector.

15. The system of claim 10, wherein the largescale dataset is compared to the at least one singular vector using cosine similarity.

16. The system of claim 10, further comprising the operation of, fine-tuning, via the at least one processor of the computing device, the at least one singular vector using cross-entropy loss.

17. The system of claim 16, wherein the at least one singular vector is orthogonal to at least one alternative singular vector.

18. The system of claim 16, wherein the step of fine-tuning the at least one singular vector further comprises, scaling, via the at least one processor of the computing device, the at least one singular vector with at least one sharpening function, thereby increasing a confidence in the at least one singular vector.

19. A method of detecting an unknown class data set within a largescale dataset, the method comprising:
calculating, via the at least one processor of the computing device, at least one singular vector for a plurality of in-distribution (hereinafter “ID”) class data of a predetermined largescale dataset, thereby establishing at least one ID class associated with the plurality of ID class data;
comparing, via the at least one processor of the computing device, a largescale dataset comprising a plurality of out-of-distribution (hereinafter “OOD”) class data with the at least one singular vector; and
automatically displaying, an uncertainty score of the largescale dataset on a display device associated with the computing device by:
based on a determination that the at least one datapoint of the plurality of OOD class data matches the at least one singular vector, labeling, recording, or both, in real-time, the at least one datapoint into the at least one ID class; and
based on a determination that the at least one datapoint of the plurality of OOD class data does not match the at least one singular vector, labeling, recording, or both, in real-time, the at least one datapoint into the at least one new OOD category.

20. The method of claim 19, further comprising the step of, pre-training, via at least one processor of the computing device, the predetermined largescale dataset, wherein the plurality of ID class data is augmented with the adversarial perturbations.
